(19) United States
(12) Patent Application Publication
(10) Pub. No.: US 2018/0018844 A1
(43) Pub. Date: Jan. 18, 2018

(54) System And Method For Transmission And Display Of Election Voting Data

(71) Applicant: Hart InterCivic Inc., Austin, TX (US)

(72) Inventors: Drew E. Tinney, Austin, TX (US); James M. Canter, Austin, TX (US)

(21) Appl. No.: 15/242,784

(22) Filed: Aug. 22, 2016

Related U.S. Application Data
(60) Provisional application No. 62/362,827, filed on Jul. 15, 2016.

(51) Int. Cl. G07C 13/00

(52) U.S. Cl. CPC G07C 13/00; G06F 12/0875; G06F 2212/45

(57) ABSTRACT

A system for collecting and aggregating voting data from a plurality of voting locations and/or voting devices is provided. The system provides for transmission of election voting data from the voting locations/devices to the central election center, to speed the collection of voting data upon the close of polls. Data may be provided to a receiving host computing system at the central election center. Data from many individual data sources is aggregated in one database and/or one memory drive, providing a many-to-one aggregation of data. A highly configurable dashboard is provided so the officials may quickly determine progress of the voting process. This dashboard may be used to provide real-time data on status of voting location/device data transmission and the storage of that data at the receiving host computing system.

### BACKGROUND OF THE INVENTION

This application claims priority to Provisional Patent Application No. 62/362,827 filed Jul. 15, 2016, the disclosure of which is expressly incorporated herein by reference

The present disclosure relates to the voting systems for elections. More specifically, it provides a system and method for transmission and display of voting information from multiple polling locations to a central election center.

A variety of voting systems and processes are well known. For example, traditionally voting data from voting precincts is transmitted from the voting precincts to a central election center for official counting, tabulation, reporting, auditing, etc. Such data may be transferred manually or may be electronically transmitted. During the election reporting process it is desirable to track the reporting status of the various voting precincts. Current central election center systems do not provide an efficient and easily visualized status of the vote report status in a real-time format.

### SUMMARY OF THE INVENTION

The present disclosure provides, in one embodiment, a system for collecting and aggregating voting data from a plurality of voting locations and/or voting devices. The system provides for transmission of election voting data (cast vote records, logs, write-in images, etc.) from the voting locations/devices to the central election center, to speed the collection of voting data upon the close of polls. Data may be provided to a receiving host computing system at the central election center. In one embodiment, as the voting data is received at a receiving host computing system, the data may be stored in a removable memory drive (such as memory drive) and/or in internal memory of the receiving host system. In one embodiment, for improved redundancy, audit trail, etc., data is stored both in a memory drive and in a database of the receiving host system internal memory. Then, the memory drive may be physically moved to a count computing system that is isolated from the host receiving computing system in order to provide “air gap” security to a count computing system. In one embodiment, the system described herein provides for a data collection technique in which data from many individual data sources (for example many voting locations or many voting devices) is aggregated in one database and/or one memory drive. Thus, many-to-one aggregation is provided at the host receiving computing system

The use of receiving host system at a central election center allows for uniquely presenting the voting data to the election officials as a single, highly configurable, dashboard so the officials may quickly determine progress of the voting process. This dashboard may also be used to provide real-time data on the voting transmission progress. Thus, the user interface is organized and presented in a manner that easily depicts transmission progress, for example, which voting locations have not started their transmission, which are in progress, or which have completed their transmission. The data granularity may be down to the polling place level, or for those polling places that have multiple reporting voting devices, down to the voting device level. In this manner, a graphical user interface is utilized that may provide a single view for visualizing all voting location transmission status and progress. In addition, the dashboard styled graphical user interface also presents status and control information to the election officials so they can review progress of the writing of the received data: how many received datasets have been written to a memory device at the central election center, progress of a current memory device being written, ability to pause the writing (and cache the data if the official so chooses).

In one embodiment a method for collecting and aggregating voting data from a plurality of voting locations is provided. The method may include transmitting the voting data from the plurality of voting locations to a receiving computing system, the receiving computing system being at a central election center and aggregating the voting data from the plurality of voting locations at the receiving computing system. The method may further include providing the aggregated voting data on a moveable memory drive, transporting the movable memory drive from the receiving computing system to a counting computer system, the receiving computing system being isolated from the counting computer system; and transferring the aggregated voting data from the moveable memory drive to the counting computer systems.

In another embodiment, an election voting system is provided. The election voting system may comprise a receiving computer system, the receiving computer system configured to receive voting data from a plurality of voting locations and aggregate the voting data at the receiving computer system. The election voting system further comprises a dashboard provided by the receiving computer system, the dashboard being a graphical user interface of the receiving computer system, the receiving computer system providing a single visualization depicting the transmission progress of voting data from the plurality of voting locations to the receiving computer system. In another embodiment, the dashboard depicts which polling locations have not started transmission of voting data to the receiving computer system and which polling places have transmitted voting data to the receiving computer system.

In another embodiment a central election center computer system is provided. The central election center computer system may comprise a receiving computer system, the receiving computer system being configured to receive voting data from the plurality of voting locations; a memory coupled to or part of the receiving computer system, the receiving computer system aggregating the voting data from the plurality of voting locations within the memory; a count computer system, the count computer system being isolated from the receiving computer system by an air gap; and a graphical user interface of the receiving computer system, the graphical user interface depicting the status of voting data received from the plurality of voting locations by depicting at least the status of how many polling locations have not started transmission of voting data and how many polling locations have transmitted voting data to the receiving computer system.

### BRIEF DESCRIPTION OF THE DRAWINGS

A more complete understanding of the present invention and advantages thereof may be acquired by referring to the following description taken in conjunction with the accompanying drawings, in which like reference numbers indicate like features. It is to be noted, however, that the accompanying drawings illustrate only exemplary embodiments of the disclosed concept and are therefore not to be considered limiting of its scope, for the disclosed concept may admit to other equally effective embodiments.

FIG. 1 illustrates exemplary voting locations and a central election center.

FIG. 2A-2D illustrate a variety of exemplary voting location configurations.

FIG. 3 illustrates an exemplary central election center configuration having a host receiving computing system and a count computing system.

FIG. 4 illustrates exemplary communications from voting locations to a central election center having multiple host receiving computing systems.

FIG. 5 illustrates a dashboard view of a graphical user interface of a host receiving computing system.

FIG. 6 illustrates exemplary memory drive status indicators.

FIG. 7 illustrates a dashboard view of a graphical user interface of a host receiving computing system while voting data reporting is in progress

FIG. 8 illustrates an exploded view of a precinct listing showing precincts at varying states.

Figures 9A-9C illustrate a variety of exemplary states for the election status portion of a dashboard of a graphical user interface of a host receiving computing system.

FIG. 10 illustrates an exemplary expanded election information display.

### DESCRIPTION OF THE PREFERRED EMBODIMENTS

The present disclosure provides a variety of voting system improvements, configurations, and techniques which may be utilized in combination or singularly, as each improvement, configuration and technique may provide advantages improvements independent of the use of the others. The techniques disclosed herein may be useful in a wide variety of voting systems, and systems disclosed herein will be recognized as merely being exemplary. As such, the improvements, configurations, and techniques will be recognized to be useful in a wide range of voting systems, and not only the exemplary systems shown and described herein.

The present disclosure provides, in one embodiment, a system for collecting and aggregating voting data from a plurality of voting locations and/or voting devices. The system provides for transmission of election voting data from the voting locations/devices to the central election center, to speed the collection of voting data upon the close of polls. Data may be provided to a receiving host computing system at the central election center. Data from many individual data sources is aggregated at in one database and/or one memory drive, providing a many-to-one aggregation of data. A highly configurable dashboard is provided so the officials may quickly determine progress of the voting process. This dashboard may be used to provide real-time data on status of voting location/device data transmission and the storage of that data at the receiving host computing system.

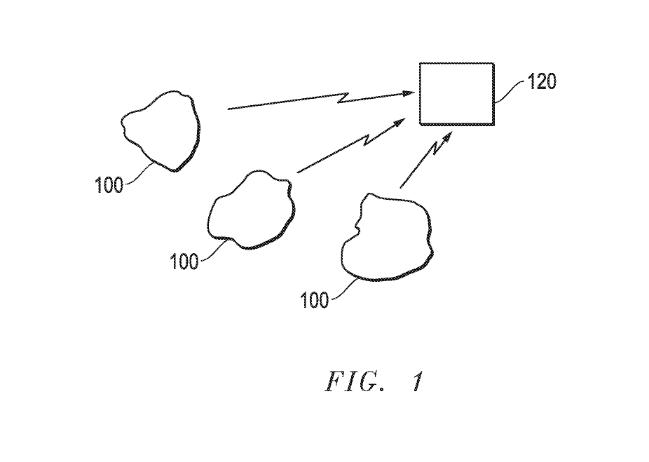

FIG. 1 illustrates at a high level one exemplary voting system. As shown in FIG. 1, a plurality of voting locations 100 are provided. Voting results from the voting locations 100 may be communicated to a central election center 120. Communication from the voting locations 100 may occur in a wide variety of manners, including manual transmission (providing an “air gap” such as in the manual movement of memory sticks, data drives, other storage media, etc. from the voting locations 100 to the central election center 120), hardwire electronic transmission, wireless electronic transmission, etc., or a combination thereof.

The voting locations 100 may be, for example, a precinct polling location, an early voting location, or the like. A scanner location at a central election center may also be considered to be a voting location 100. At such a scanner location, one or more ballot scanners located at a central election center may be provided for processing paper ballots (for example absentee or mail in ballots). At the voting locations, one or more voting devices may be provided for recording a voter's vote. The voting devices may be direct recording electronic (DRE) voting devices, other electronic voting devices, paper ballot voting devices, etc. The voting devices may be stand-alone devices or may be networked voting devices. Data may be transmitted from the voting locations 100 to the central election center 120 in a wide variety of manners as is known in the art. For example, voting devices at the voting locations 100 may be networked together. The voting data from the networked voting devices at a voting location may be provided to a single network controller at the voting location 100. Voting records, such as cast vote records, may then be transmitted from the network controller to the central election center 120 manually (via memory sticks, memory drives, other storage media, etc.), via hardwire electronic transmission (for example via the Internet), via wireless transmission, or any other method as known in the art. In an alternative approach, the voting devices at a voting location 100 may each individually transmit voting data to the central election center 120 using any of such methods of transmission. As will be understood upon review of this disclosure, the concepts described herein are not limited to particular types or configurations of voting devices, voting locations, or transmission methods used to provide data to a central election center. Thus, the particular voting locations, voting devices, and voting data transmission methods described herein will be recognized to be merely exemplary.

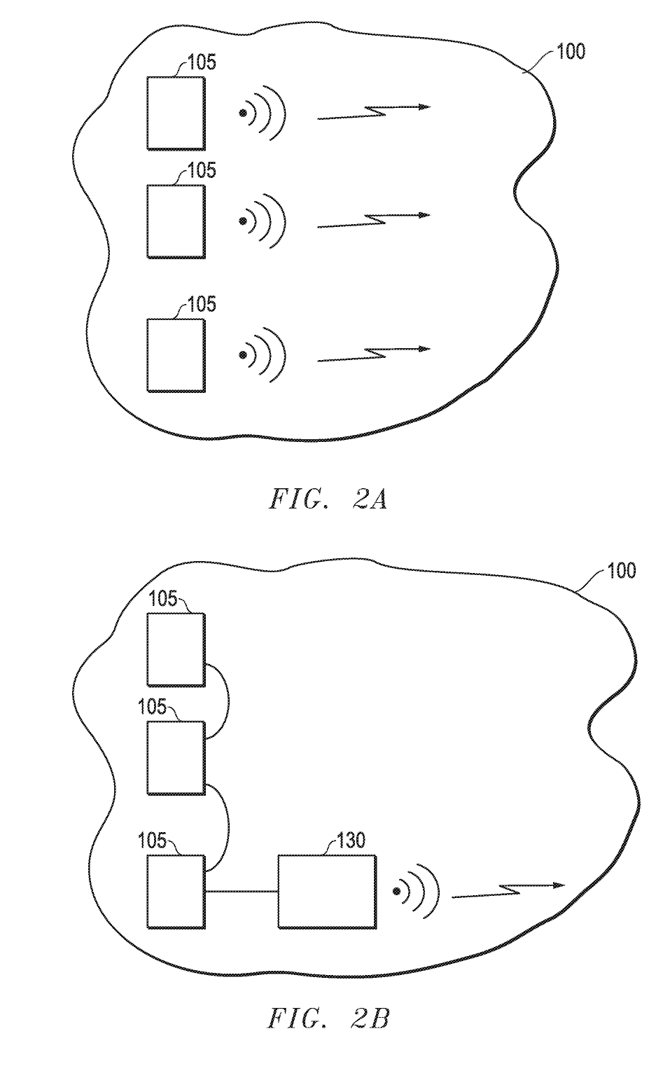

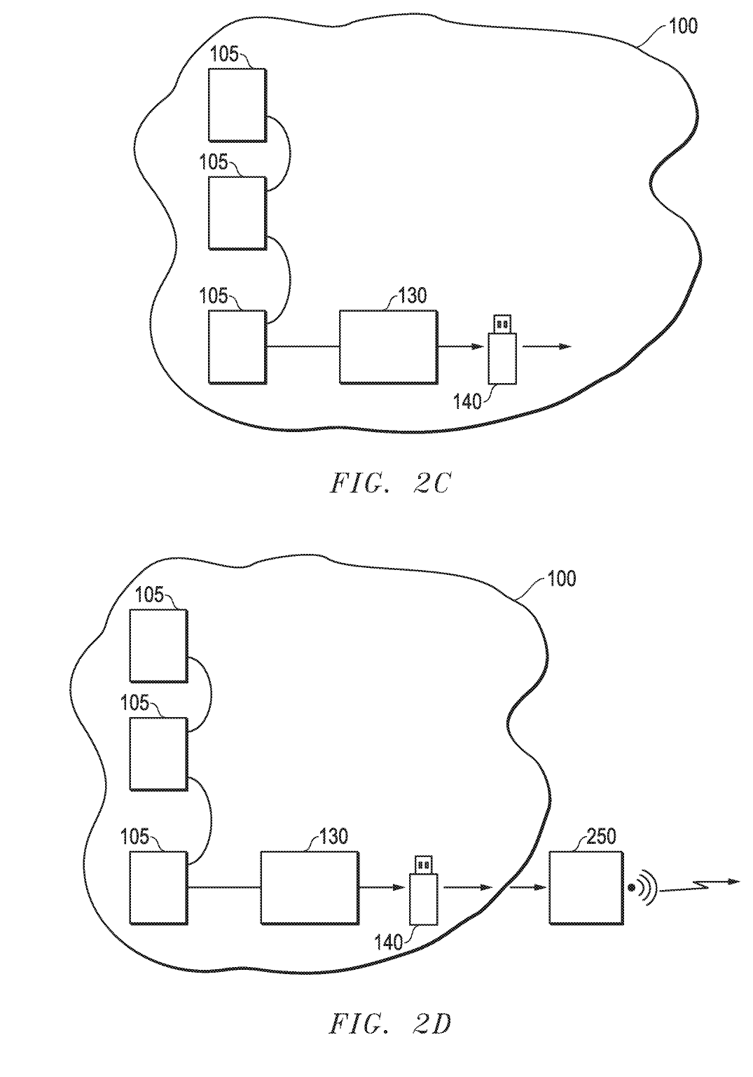

FIGS. 2A-2D illustrate exemplary voting locations 100, though as mentioned, many other configurations may be utilized. As shown in FIG. 2A, one or more voting devices 105 may be provided. In the embodiment of FIG. 2A, each voting device may independently transmit its voting records to the central election center 120 via wireless communication. As mentioned, alternatively such transmission may be via hardwire electrical communication, manual movement of data drives or storage media, etc. As shown in FIG. 2B, voting devices 105 may be networked together. In this exemplary embodiment, a network controller 130 transmits voting records to the central election center 120 via wireless communication. FIG. 2C illustrates a variation of the voting location 100 of FIG. 2B in which the data is transmitted via a memory drive 140. Alternatively, memory drives 140 may be utilized individually with each voting device, in a configuration that would be more akin to FIG. 2A. FIG. 2D illustrates a configuration similar to that of FIG. 2C except an additional aggregation transmission station 250 is utilized. Aggregation transmission station 250 may be utilized in a configuration in which transfer memory devices 140 from a number of voting locations 100 are transported to an aggregation location that serves as the transmission station to the central election center 120. The aggregation transmission station 250 may be at a location separate from the voting locations 100 and the central election center 120. Alternatively, the aggregation transmission station 250 may be located at a particular voting location or may even be located at the central elections center 120. Such a configuration reduces the total number of transmission stations, and instead has the memory devices 140 manually transported to an aggregation location, and then remote transmitted to the central election center 120. Such a configuration reduces cost as each polling place device need not have wireless transmission capability. Rather, if many small localities need to send their data to the central elections office, yet have geographic distance to the central election office, they can bring their memory devices with vote data to an aggregation location, and from there use an aggregating transmission station 250 to send the vote data. It will be recognized that these examples are merely illustrative and many other configurations of the voting locations and the transmission methods may be utilized in conjunction with the concepts described herein.

The voting data transmitted from the voting location can take a wide range of forms in accordance with various jurisdictional and system requirements. For example, the voting data may include cast vote records which reflect a voter's intent. Further, write-in images may be included. In addition, logs and other workflow information from the voting device and/or other devices at the voting location may be provided. The data may be transmitted as individual records, for example individual XML based records, or the data may be transmitted as sets of records. The data may be compressed, encrypted or further processed in a wide variety of manners. Data transmitted from the voting location may occur at a variety of times, dependent of course upon the data transmission technique. Alternatively, the voting data may be transmitted electronically when the polls close (either automatically or through a process initiated by election poll workers). Data manually transmitted (such as on memory drives), may typically be transmitted when polls close.

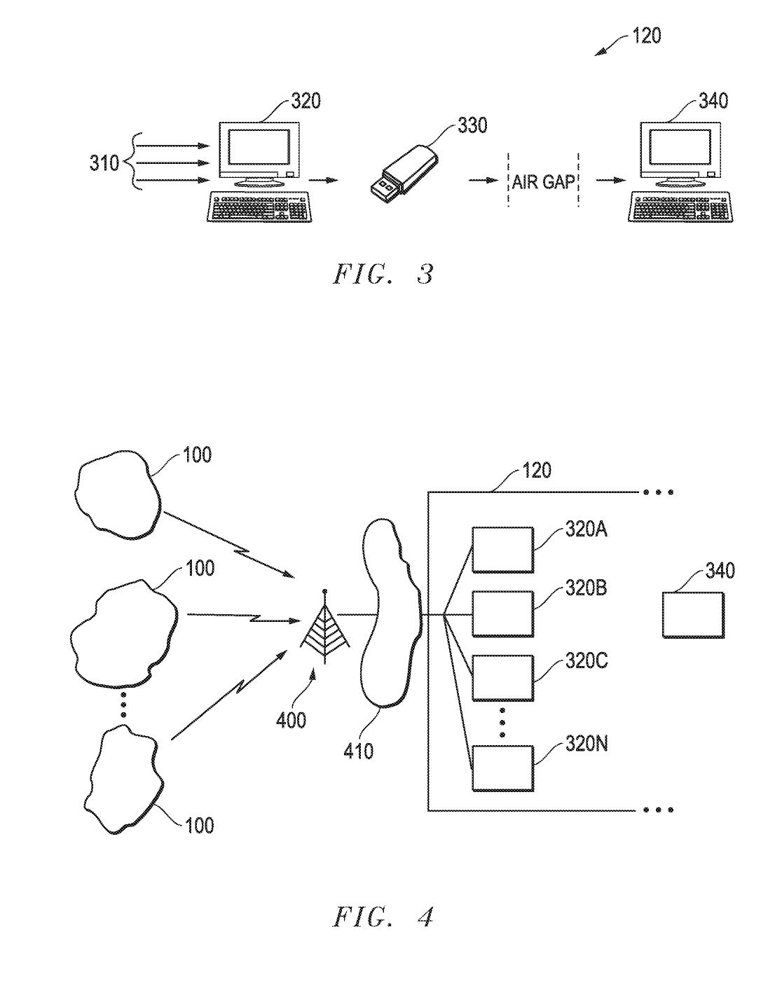

FIG. 3 illustrates exemplary systems and processing at the central election center 120. As shown in FIG. 3, data 310 is received from the voting locations 100 in any format or transmission method, such as those described above. Thus, data 310 may be presented in the form of data drives, storage media, wireless transmissions, hardwired electronic transmissions, etc. Though the central election center 120 may be considered to one centralized center, it will be recognized that the centralized election center 120 may be spread across a number of physical/geographical locations, hardware configurations and/or software platforms, all as would be known in the art. Receiving host system 320 and count system 340 are provided at the central election center. Receiving host computing system 320 and count computing system 340 may take the form of any of a wide variety of computing platforms. For example either or both systems may be one or more of personal computer based systems, server based systems, notebook based systems, laptop based systems, mobile computing systems, or any other of a wide range of computing systems which may be configured to process voting data. The systems may further include any of a wide range of software configurations, all as would be known in the art.

As will be discussed in more detail below, data 310 includes data provided from a plurality of voting locations. Receiving host system 320 collects and aggregates the voting data from the plurality of voting locations, and as described below provides the data to election officials in an efficient and usable format. The receiving host system 320 may then package the received voting data for communication to count system 340. The count system 340 may be used to provide final official vote tabulation and counts, election audit mechanisms, archival mechanisms, etc. As shown in FIG. 3, voting data may be communicated from the receiving host system 320 to the count system 340 via a memory drive 330 (in one example a memory stick). As shown, one memory drive 330 is provided, however, the system may be configured to utilize a plurality of memory drives. Use of the memory drive 330 enables the establishment of an “air gap” to be provided between the receiving host system 320 and the count system 340. The air gap may add in isolating the two systems to provide more security and integrity to the overall voting process. Thus, advantageously, the count system may be isolated and segregated from other components of the voting system. Communication may be made to the central election center in a non-isolated manner (for example hardwired network communications or wireless network communications), yet the configuration still provides a mechanism to isolate key central election center systems such as the count system 340. In this manner, another layer of security is provided to the overall voting system. The concepts and techniques described herein, however, are not limited to the use memory drives and other data transmission techniques between the host system 320 and the count system 340 may be utilized.

The system described herein provides for transmission of election voting data (cast vote records, logs, write-in images, etc.) from the voting locations to the central election center, to speed the collection of voting data upon the close of polls. Thus, as described above data from a plurality of voting location transmission devices may be provided to a receiving host system at the central election center. As the voting data is received at a receiving host system, the data may be stored in a removable memory drive (such as memory drive 330) and/or in internal memory of the receiving host system. In one embodiment, for improved redundancy, audit trail, etc., data is stored both in memory drive 330 and in a database of the receiving host system 320 internal memory.

In one exemplary embodiment, the receiving host system 320 may operate in two modes of operation: (1) memory drive present mode and (2) no memory drive present mode. When a memory drive(s) is present the receiving host system 320 may stream incoming voting data (such as cast vote records) received at inputs 310 to the inserted memory drive(s). Thus, as voting data is received, the voting data may be streamed directly to the memory drive in real-time of the reception at the receiving host system 320. This mode may be configured in a variety of manners. For example, the receiving host system 320 may be configured to automatically write data to a memory drive when a memory drive is detected. Alternatively, the system may be configured to write data to the memory drive at the command of an election official (for example activating a write memory setting). For redundancy purposes (in case of a lost memory drive, malfunctioning memory drive etc.), data may also be stored in the database of the internal memory of the receiving host system 320. Thus, if a problem exists with the primary transmission media, data may be written to a secondary transmission media from the internal memory of the receiving host system. If the memory drive is present but is full, data will only be stored in the internal memory, and operation will proceed as described below in the case of no memory drive present.

In the second mode of operation (no memory drive present), the incoming voting data is automatically cached in the database of the internal memory of the receiving host system 320. Voting data will continue to be cached until a memory drive is inserted. At such time, cached voting data and new incoming voting data will be streamed to the memory drive, either automatically or at the command of an election official, depending upon how the system is configured.

As described in more detail below, the receiving host system 320 may include a visual dashboard that provides a number of indicators to election officials. The indicators may include the status of, capacity of, number of, etc., memory drives. The writing to a memory drive may be paused by an election official by removing a memory drive. Alternatively, a button or icon may be provided on the receiving host system 320 dashboard to provide a pause of memory drive writing capabilities when clicked. When writing is paused, the system may be configured to continue to cache voting data in the database of the receiving host system 320, however, automatic writing to the removable memory drive 330 will halt.

The system described herein provides for a data collection technique in which data from many individual data sources (for example many voting locations or many voting devices) is aggregated at in one database and/or one memory drive. Thus, a jurisdiction may have tens to hundreds of polling place locations, each of which can have multiple voting devices, all of which have to be tracked for transmission of their data upon polls closing. This voting data may all be aggregated at the receiving host system 320. In the case of voting data that is transferred from the voting locations 100 to the receiving host system 320 on memory drives 140, each voting device (or network controller as the case may be) may have a one-to-one correspondence between the memory drives 140 and the corresponding voting device (or network controller as the case may be). The receiving host system 320 then converts this to a many-to-one arrangement with regard to one memory drive containing data from many voting devices. One benefit of such an arrangement is the streamlined performance in generation of the election results, as the quantity of media required to go to the count system 340 is greatly reduced due to the cumulative effect of the many-to-one relationship.

The files containing the many-to-one conversion of the data may be organized in a manner that retains identify of origin and work flow of the data even though the data may be ultimately transferred on one memory drive to the count system 340. Thus, the data may be organized in nested sets of cast vote records and logs that are organized by voting device, voting location, voting network controller, receiving host system, etc. Maintaining these sets will enable satisfying any requirements to track chain of custody for cast vote records and logs when the records and logs are transferred between systems.

FIG. 4 illustrates yet another embodiment. As shown in FIG. 4, the central election center 120 may include a plurality of receiving host systems 320A, 320B, 320C, . . . 320N, in addition to the count system 340. Further, a plurality of voting locations 100 are indicated that communicate wirelessly with a local wireless receiver station 400 (for example a cellular network). As is known, the wireless receiver station 400 may couple data received at the receiver station 400 to the Internet 410. The receiving host systems 320A, 320B, 320C . . . 320N may be coupled to the Internet through standard switches, routers, etc. as is known in the art. In one embodiment, there may be hundreds of voting locations that report to the central election center. The use of multiple receiving host systems may be configured such that predefined sets of voting locations (or devices at a location) communicate with designated receiving host systems. The control of which voting locations and/or which voting devices at a location report to which receiving host system may be accomplished by configuring the voting locations/devices to report to the IP address of a particular receiving host system. Thus, the number of receiving host systems may be scaled depending upon the anticipated data load. In yet another embodiment, a load balance technique may be used to dynamically allocate voting data traffic amongst the receiving host systems.

In an alternative embodiment, one or more of the receiving host systems may be designated as a primary receiving host system. In normal operations, all voting data traffic may be routed to the primary receiving host system. However, in case of an inability to establish proper communications between a voting location 100 and the primary receiving host system, voting data traffic may be routed to a failover receiving host system. In such an arrangement, voting data traffic may be re-routed to failover receiving host system in circumstances such as equipment failure at the primary receiving host system, data traffic overload at the primary receiving host system, etc. The overall voting system may be preconfigured such that equipment at the voting locations 100 is provided the various IP addresses, and priority scheme, of the receiving host systems. In yet an another embodiment, the receiving host systems may be configured as a combination of a one or more primary receiving host systems, additional receiving host systems utilized to scale for the number of reporting devices, and failover receiving host systems. As it is expected that large bursts of data would be transmitted to the central election center 120 from the voting locations 100 at substantially similar times (when the polls close), the equipment at the voting locations may be provided with a randomizing algorithm so as to slightly stagger the communications with the central election center so as to minimize data overload conditions. In yet another embodiment, in the presence of multiple receiving host systems, the receiving host systems may be networked together so that all the data collected at each individual receiving host system may be aggregated at one primary receiving host system.

The use of receiving host system 320 at a central election center 120 allows for uniquely presenting the voting data to the election officials as a single, highly configurable, dashboard so the officials may quickly determine progress of the transmissions underway. This dashboard may also be used to provide real-time data on the number of voting locations for which voting data has been reported, which locations still have outstanding data, etc. The user interface is organized and presented in a manner that easily depicts transmission progress: which voting locations have not started their transmission, which voting locations are in progress, or which voting locations have completed their transmission. The transmission progress may be shown down to the polling place level, or for those polling places that have multiple reporting voting devices, down to the voting device level. In this manner, a user interface is provided that may provide a single view for visualizing voting location transmission status and progress. As mentioned, this view may even provide granularity down to the individual voting device at a voting location.

In addition, the dashboard styled graphical user interface also presents status and control information to the election officials so they can review progress of the writing of the received data: how many received datasets have been written to a memory device 330 at the central election center 120 (written with the received election results), progress of a current memory device 330 being written, ability to pause the writing (and cache the data if the official so chooses). Further, overall progress of the voting: how many voting locations/devices have reported their data (are complete), how many remain to be reported, etc. may be reported together with the writing status data in one simple dashboard.

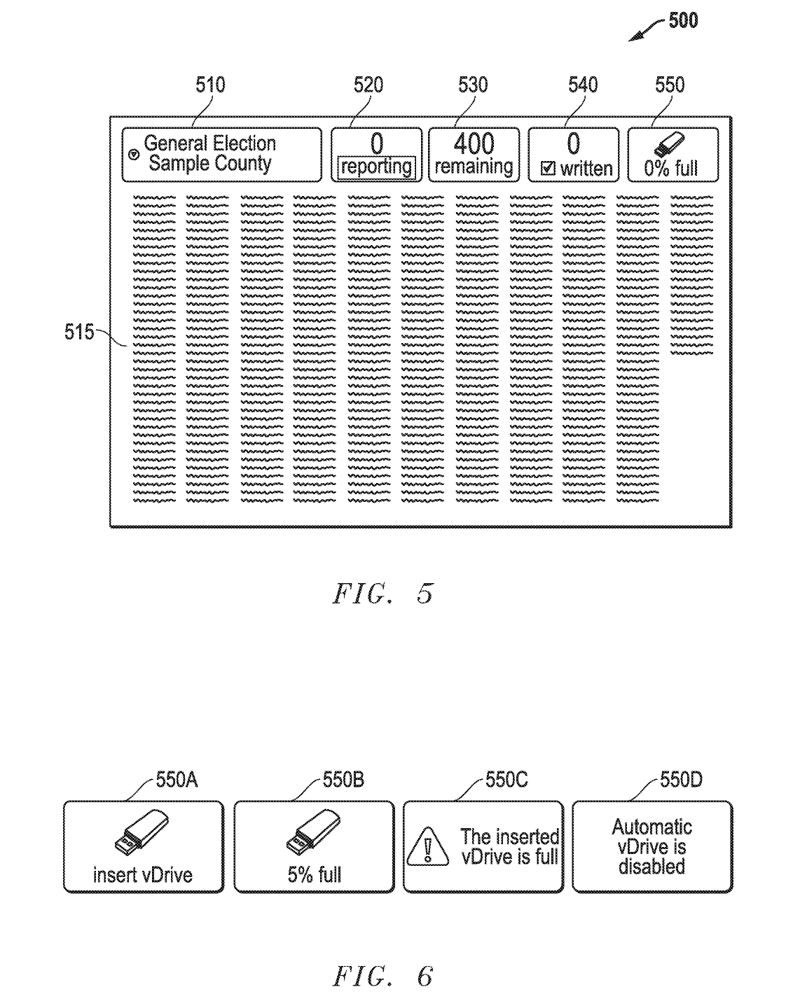

FIG. 5 illustrates an example dashboard for use of the techniques described herein. As shown, FIG. 5 provides an exemplary graphical user interface of a display screen of the receiving host system 320. The display could take any of many forms, for example, a stand-alone monitor, a screen of a laptop, a screen of a mobile device, etc. The graphical user interface 500 may include a variety of details regarding the status of an election and the voting data at the receiving host system. It will be recognized that the details provided in the graphical user interface of FIG. 5 are merely illustrative. The graphical user interface 500 includes an election information display 510, in this case indicating a general election in “Sample County.” The graphical user interface 500 further includes a precinct listing 515 of each precinct polling location in the county. Though not shown in detail, the precinct listing may be a textual listing of the name of each precinct. A polling place reporting indicator 520 indicates the number of polling places that have reported voting data and a polling place remaining indicator 530 indicates the number of polling places remaining that have not reported. The voting records written indicator 540 indicates the amount of voting data that has been written to a memory drive 330 of the host receiving system 320. The memory drive indicator 550 provides a status of a currently inserted memory drive 330 of the host receiving system 320. The indicators 510, 520, 530, 540 and 550 may take the form of merely alphanumeric data, icons, or a combination thereof. Together, the indicators 510, 520, 530, 540 and 550 represent an election status portion of the graphical user interface 500. It will be recognized that more or less indicators may be utilized for the election status portion of the graphical user interface 500, as particular indicators may be a design choice of the system developer.

The memory drive indicator 550 may provide various information regarding the status of memory drive 330. FIG. 6 illustrates exemplary states of the memory drive indicator. Thus, the memory drive indicator may indicate that a memory drive needs to be inserted into the host receiving system 320, as indicated by memory drive indicator 550A. Similarly, as indicated by memory drive indicator 550B, a percentage of available space that is currently used is provided. Also, as indicated by memory drive indicator 550C, the memory drive 330 is completely full. Finally, as indicated by memory drive indicator 550D, the streaming status to a memory drive may be hard disabled, thus the system being configured to not allow real-time streaming of data to a memory drive. Further, by clicking or hovering over the memory drive indicator a user may select to pause writing to the memory drive. In such case, as described above, voting data will be retained in the database of the internal memory of the host receiving system. Writing may continue to the memory device when reactivated by the user.

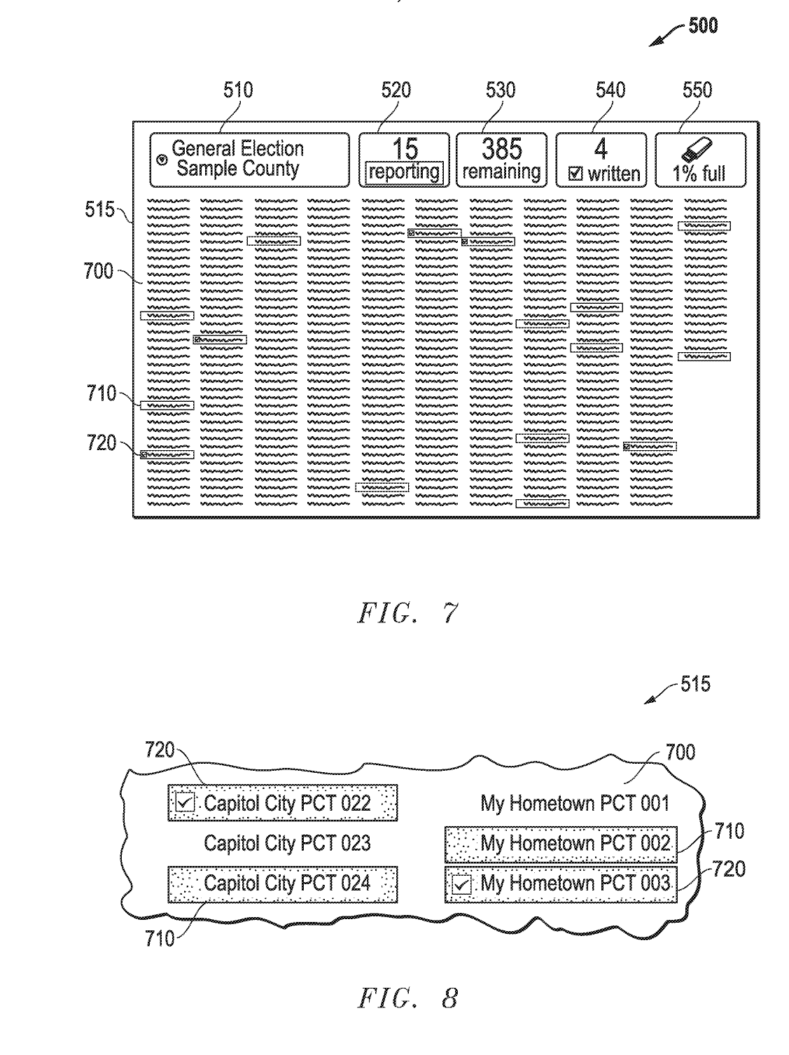

FIG. 7 illustrates the election of FIG. 5 after precincts have begun reporting. As shown in FIG. 7, the election status portion of the graphical user interface 500 indicates that 15 precincts have reported data and 385 precincts still need to report data. Further, of the 15 precincts that have reported data, 4 have been written to the memory drive 330. As shown in FIG. 7, the memory drive 330 is 1% full. The precinct listing 515 is configured to provide additional information regarding the precincts beyond a mere listing of the precincts. Thus, as shown, precincts that are not shaded (for example precinct 700) are precincts for which voting data has not been reported. Precincts that are shaded (for example precinct 710) are precincts for which data has been reported. Precincts which have been reported and have been written to the memory drive 330 (for example precinct 710) are shown as both shaded and with a “check” mark. An exploded precinct listing 515 is shown in FIG. 8 to illustrate a variety of precincts having differing status 700, 710 and 720.

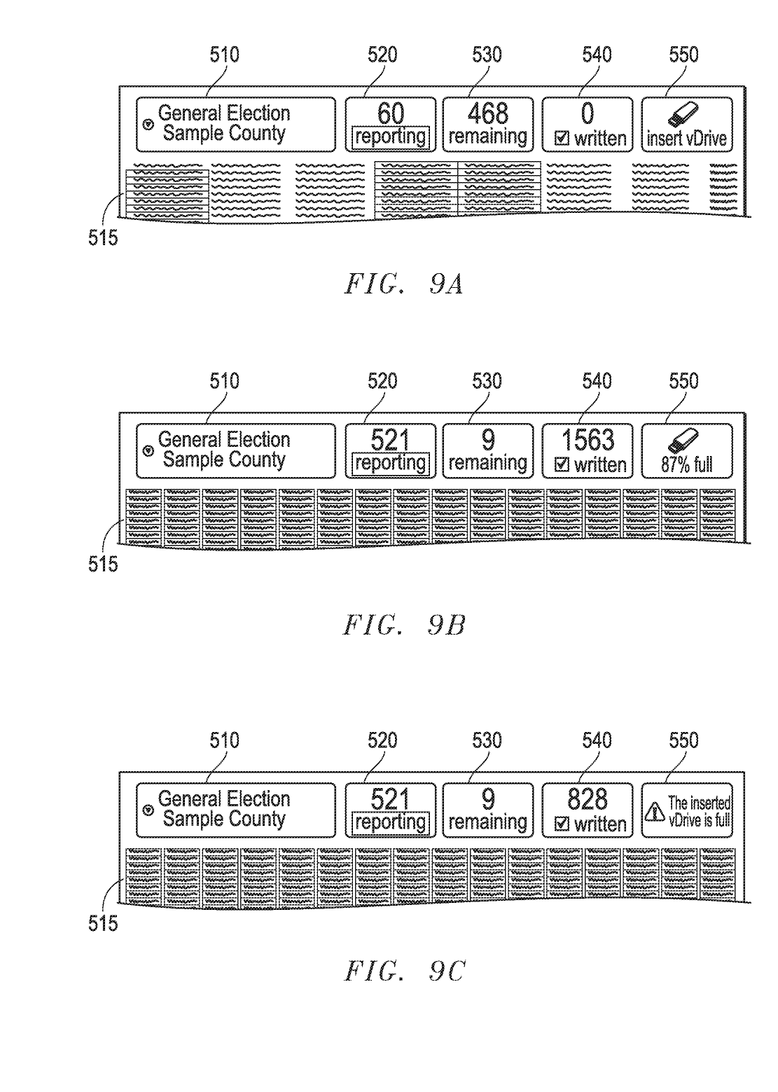

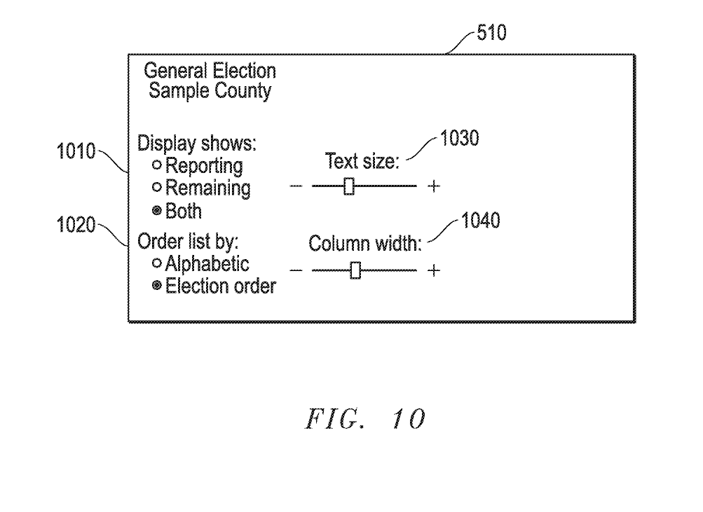

FIGS. 9A-9C illustrate the election status portion of a graphical user interface 500 in a variety of exemplary states for the polling place reporting indicator 520, polling place remaining indicator 530, voting records written indicator 540 and memory drive indicator 550. The indicators 520, 530 and 540 may also be configured such that hovering or clicking on the indicated may switch the views dashboards from all precincts to only precincts reporting, to only precincts not reporting or only precincts written.

It will be recognized that the amount of voting data presented on the graphical user interface 500 of the of the receiving host system 320 may be large, particularly for large jurisdictions. In such cases, the precinct listing 515 may be quite extensive. In order to manage the visual display of the information in a convenient dashboard view, various mechanisms may be provided to manage the view presented in the graphical user interface 500. For example, the election information display 510 may be configured to also provide viewing options to a user. In one example, clicking or hovering on the election information display 510 may expand the election information display 510 to provide additional user viewing options for different precinct listing options. FIG. 10 illustrates one exemplary election information display 510 in an expanded format. As shown in FIG. 10, user display selector 1010 allows a user to display only reporting precincts, only remaining precincts or both. User display selector 1020 allows a user to configure the order of the listing of the precincts, for example alphabetically, election order, etc. Further, zooming options may be provided with regard to the text size and column sizes of the precinct listing 515. Thus, text size selector 1030 and column width selector 1040 are provided as shown.

Thus as described a graphical user interface is provided that in one single dashboard provides a clear visualization of the status of the election process as reflected at the host receiving system. Actual data is presented in an efficient manner through alphanumeric representations. Further, other visual indicators such as icons, shading, check marks, etc. are also provided in addition to alphanumeric data indicators so that a user may quickly and easily evaluate the status of an election process. The visual indicators may include the status of a memory drive at the host receiving system, such as not inserted, percent full and full status. The visual indicators may also indicate the number of datasets that have been written to a memory drive. The dashboard may conveniently be able to switch views from all voting locations, to voting locations reporting to voting locations not reporting. Further the ability to configure the font size and column width “on the fly” to zoom in/out on voting location transmission activities is also provided. Further, the dashboard provides the ability to pause writing to a memory device.

In this manner a wide range of reporting metrics may be presented to an election official and the visualization of such networks may be controlled in an easy manner. It will be recognized that the reporting metrics provided herein are merely exemplary and other metrics may be utilized depending upon the overall election process and voting location configurations. For example, the dashboard described above is presented in a fashion in which a precinct listing is provided. The precinct listing may alternatively be a listing of voting locations. In another alternative, each voting location may provide one individual report for voting data (for example via a memory drive 140 such as shown in FIG. 2C). However, an election system may be configured such as shown in FIG. 2A in which every voting device individually provides voting data. In such case the voting location listing may be changed to a voting device listing. Alternatively, individual voting devices may be affiliated with a voting location (precinct, early voting polling place, etc.). The voting location or precinct listing may include data listing the number or percent of voting devices at a voting location/precinct that have reported. In yet another embodiment, hovering or clicking on a voting location/precinct may provide the additional data with regard to the particular voting devices at that location or precinct. Using these techniques, the data viewable on the graphical user interface may provide a visualization of all of the vote tabulators at a voting location. Thus, it will be recognized that the configuration of a graphical user interface at a host receiving system may be changed in a variety of manners, depending upon the particular configuration of the overall voting process and equipment.

Further modifications and alternative embodiments of this invention will be apparent to those skilled in the art in view of this description. Accordingly, this description is to be construed as illustrative only and is for the purpose of teaching those skilled in the art the manner of carrying out the invention. It is to be understood that the forms and methods of the invention herein shown and described are to be taken as presently preferred embodiments. Equivalent techniques may be substituted for those illustrated and describe herein and certain features of the invention may be utilized independently of the use of other features, all as would be apparent to one skilled in the art after having the benefit of this description of the invention.

What is claimed is:

1. A method for collecting and aggregating voting data from a plurality of voting locations, comprising:
transmitting the voting data from the plurality of voting locations to a receiving computing system, the receiving computing system being at a central election center;
aggregating the voting data from the plurality of voting locations at the receiving computing system;
providing the aggregated voting data on a moveable memory drive;
transporting the movable memory drive from the receiving computing system to a counting computer system, the receiving computing system being isolated from the counting computer system; and
transferring the aggregated voting data from the moveable memory drive to the counting computer systems.

2. The method of claim 1, the receiving computing systems being configured stream incoming voting data to the moveable memory drive in real-time.

3. The method of claim 1, the receiving computing system being configured to cache incoming voting data in an internal memory.

4. The method of claim 1, the receiving computing system being configured to selective stream incoming voting data to the moveable memory drive in real-time or cache incoming voting data in an internal memory.

5. The method of claim 1, the isolation of the receiving computing system and the counting computer system being provided by an air gap between the two systems, such that the two systems are not in electrical communication.

6. The method of claim 1, further comprising providing a plurality of receiving computer systems at the central election center.

7. The method of claim 6, wherein at least one receiving computer system is a primary receiving computer system and at least one receiving computer system is a failover receiving computer system.

8. The method of claim 6, wherein load balancing techniques are utilized to balance the provision of voting data from the plurality of voting locations amongst the plurality of receiving computer systems.

9. The method of claim 1, wherein the receiving computer system provides a single dashboard providing a visualization of the transmission status of all of the plurality of voting locations.

10. An elections voting system, comprising:
a receiving computer system, the receiving computer system configured to receive voting data from a plurality of voting locations and aggregate the voting data at the receiving computer system; and
a dashboard provided by the receiving computer system, the dashboard being a graphical user interface of the receiving computer system, the receiving computer system providing a single visualization depicting the transmission progress of voting data from the plurality of voting locations to the receiving computer system.

11. The elections voting system of claim 10, the dashboard providing real-time data regarding the transmission progress of the voting data.

12. The elections voting system of claim 11, the receiving computer system being located at a central elections center and being configured to be isolated from a count computer system.

13. The elections voting system of claim 11, the dashboard depicting which polling locations have not started transmission of voting data to the receiving computer system and which polling places have transmitted voting data to the receiving computer system.

14. The elections voting system of claim 13, the dashboard further depicting which polling locations have had voting data written to a moveable memory drive.

15. The elections voting system of claim 13, the dashboard being configurable to depict only the polling locations that have not started transmission of voting data to the receiving computer system or only the polling locations that have transmitted voting data.

16. The elections voting system of claim 10, the dashboard depicting the status of a moveable memory drive, the moveable memory drive being provided so that the aggregated voting data may be written to the moveable memory drive.

17. The elections voting system of claim 16, the status of the moveable memory drive being the presence of the moveable memory drive or the capacity used of the memory drive.

18. The elections voting system of claim 10, the dashboard providing visual indicators of a status of the voting data transmission of individual polling locations.

19. A central election center computer system, comprising:
a receiving computer system, the receiving computer system being configured to receive voting data from the plurality of voting locations;
a memory coupled to or part of the receiving computer system, the receiving computer system aggregating the voting data from the plurality of voting locations within the memory;
a count computer system, the count computer system being isolated from the receiving computer system by an air gap; and
a graphical user interface of the receiving computer system, the graphical user interface depicting the status of voting data received from the plurality of voting locations by depicting at least the status of how many polling locations have not started transmission of voting data and how many polling locations have transmitted voting data to the receiving computer system.

20. The central election center computer system of claim 19, wherein the graphical user interface depicts which polling locations have not started transmission of voting data to the receiving computer system and which polling places have transmitted voting data to the receiving computer system.

21. The central election center computer system of claim 20, the memory being a moveable memory, the receiving computer system and the count computer system being configured to transfer data between the receiving computer system and the count computer system via the moveable memory drive.

22. The central election center computer system of claim 20, the graphical user interface further depicting the status of the memory, the memory being a moveable memory drive.

23. The central election center computer system of claim 22, the graphical user interface allowing a user to selectively control writing voting data to the moveable memory drive.
